(19) United States
(12) Patent Application Publication
(10) Pub. No.: US 2025/0356089 A1
(43) Pub. Date: Nov. 20, 2025

(54) COMPUTER PROGRAM, INFORMATION PROCESSING METHOD, AND INFORMATION PROCESSING DEVICE

(71) Applicant: Tokyo Electron Limited, Tokyo (JP)

(72) Inventor: Kaoru SAKO, Sapporo-shi (JP)

(73) Assignee: Tokyo Electron Limited, Tokyo (JP)

(21) Appl. No.: 19/284,845

(22) Filed: Jul. 30, 2025

Related U.S. Application Data
(63) Continuation of application No. PCT/JP2024/002725, filed on Jan. 30, 2024.

(30) Foreign Application Priority Data
Feb. 1, 2023 (JP) 2023-014239

(51) Int. Cl. G06F 30/3308; G06F 30/347

(52) U.S. Cl. CPC G06F 30/3308; G06F 30/347

(57) ABSTRACT

A non-transitory computer-readable storage medium, an information processing method, and an information processing device capable of visualizing an effect of a processing step on a processing result of a substrate are provided. The transitory computer-readable storage medium causes a computer to execute information processing of: acquiring a first recipe including a plurality of processing steps for processing a substrate, and a second recipe in which a part of processing steps is different from those in the first recipe, calculating, by a simulation, predicted shapes of the substrate processed according to the first recipe and the second recipe, and displaying the predicted shape corresponding to the first recipe and the predicted shape corresponding to the second recipe, and the processing steps that are different between the first recipe and the second recipe.

### CROSS-REFERENCE TO RELATED APPLICATIONS

This application is a bypass continuation application of international application No. PCT/JP2024/002725 having an international filing date of Jan. 30, 2024 and designating the United States, the international application being based upon and claiming the benefit of priority from Japanese Patent Application No. 2023-014239, filed on Feb. 1, 2023, the entire contents of each are incorporated herein by reference.

### TECHNICAL FIELD

The present disclosure relates to a computer program, an information processing method, and an information processing device.

### BACKGROUND

Substrate processing, which involves etching or the like, on a substrate such as a semiconductor wafer is performed according to a recipe that defines processing contents. The recipe is a combination of a plurality of processing steps in a set order, and processing contents of each processing step are set. In related art, a shape simulation is performed using a computer to predict a shape of a substrate obtained by substrate processing. Patent Document 1 discloses a technique of searching for an appropriate recipe by using a shape simulation.

### CITATION LIST

### Patent Documents

Patent Document 1: WO2019/155928

### SUMMARY

When any of processing steps included in a recipe is changed, processing contents are changed, and a processing result is also changed. The search for the recipe relied heavily on experience of engineers and trial and error.

The present disclosure provides a computer program, an information processing method, and an information processing device capable of visualizing an effect of a processing step on a processing result of a substrate.

A computer program according to an aspect of the present disclosure causes a computer to execute information processing of: acquiring a first recipe including processing steps for processing a substrate, and a second recipe in which a part of processing steps is different from those in the first recipe, calculating, by a simulation, predicted shapes of the substrate processed according to the first recipe and the second recipe, and displaying the predicted shape corresponding to the first recipe and the predicted shape corresponding to the second recipe, and the processing steps that are different between the first recipe and the second recipe. The computer program may cause the computer to execute information processing of processing the substrate using one of the first recipe and the second recipe.

According to the present disclosure, a computer program, an information processing method, and an information processing device capable of visualizing an effect of a processing step on a processing result of a substrate can be provided.

### BRIEF DESCRIPTION OF DRAWINGS

FIG. 1 is a block diagram illustrating an example of an internal configuration of an information processing device;

FIG. 2 is a chart illustrating an example of contents of a processing step database;

FIG. 3 is a chart illustrating an example of contents of recipe data;

FIG. 4 is a flowchart illustrating an example of a procedure of information processing for visualizing an effect of a processing step that is executed by the information processing device;

FIG. 5 is a schematic diagram illustrating a first display example of predicted shapes and processing steps included in each recipe;

FIG. 6 is a schematic diagram illustrating an example of a three-dimensional shape of a hole formed in a substrate;

FIG. 7 is a schematic cross-sectional view illustrating an example of a cross section of the substrate taken along a depth direction of the hole;

FIG. 8 is a schematic cross-sectional view illustrating an example of a cross section of the substrate along a direction intersecting the depth direction of the hole;

FIG. 9 is a schematic diagram illustrating a second display example of predicted shapes and processing steps included in each recipe;

FIG. 10 is a flowchart illustrating an example of a procedure of information processing for displaying predicted shapes corresponding to a plurality of comparison recipes that is executed by the information processing device; and

FIG. 11 is a schematic diagram illustrating an example of a list of recipes.

### DETAILED DESCRIPTION

Hereinafter, the present disclosure will be specifically described with reference to the drawings illustrating an embodiment thereof.

A process for producing a substrate such as a semiconductor wafer, a glass substrate, or a flat panel substrate includes a process of performing processing such as etching or film formation on a substrate. Hereinafter, the processing performed on the substrate will be referred to as substrate processing, and a device for executing the substrate processing will be referred to as a processing device. For example, the processing apparatus is a process chamber, and processes, such as etching is performed on the substrate disposed in the process chamber. The processing device processes the substrate according to a predetermined recipe in which processing contents are set. The recipe includes a plurality of processing steps in a set order. Each processing step is a smallest unit of a time series processing procedure for the substrate. In each processing step, contents of processing to be performed on the substrate are determined. There may be a plurality of recipes having different processing steps. In the present embodiment, information processing is executed to visualize an effect of the processing step on a processing result of the substrate.

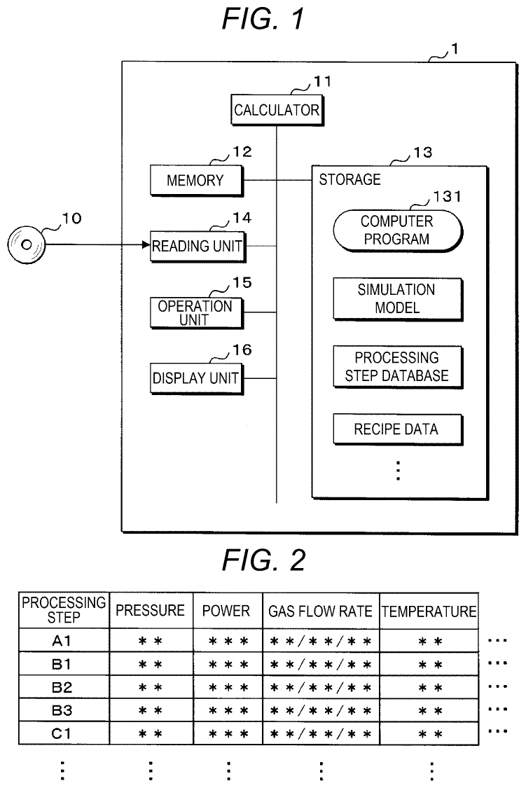

FIG. 1 is a block diagram illustrating an example of an internal configuration of an information processing device 1. The information processing device 1 executes an information processing method. The information processing device 1 is implemented using a computer such as a personal computer or a server device. The information processing device 1 includes a calculator 11, a memory 12, a storage 13, a reading unit 14, an operation unit 15, and a display unit 16. The calculator 11 is implemented using, for example, a central processing unit (CPU), a graphics processing unit (GPU), or a multi-core CPU. The calculator 11 may also be implemented using a quantum computer. The memory 12 stores temporary data generated along with calculation. The memory 12 is, for example, a random access memory (RAM). The storage 13 is non-volatile, and is, for example, a hard disc or a non-volatile semiconductor memory. The reading unit 14 reads information from a recording medium 10 such as an optical disc or a portable memory. The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

The operation unit 15 receives an input of information such as text by receiving an operation from a user. The operation unit 15 is, for example, a keyboard, a pointing device, or a touch panel. The display unit 16 displays an image. The display unit 16 is, for example, a liquid crystal display or an electroluminescent display (EL display). The operation unit 15 and the display unit 16 may be integrated.

The calculator 11 causes the reading unit 14 to read a computer program (program product) 131 recorded in the recording medium 10, and causes the storage 13 to store the read computer program 131. The calculator 11 executes information processing for implementing functions of the information processing device 1 according to the computer program 131. The computer program 131 may be stored in advance in the storage 13 or may be downloaded from outside the information processing device 1. In this case, the information processing device 1 does not need to be provided with the reading unit 14.

The computer program 131 may be loaded to be executed on a single computer or on a plurality of computers disposed at one site or distributed across a plurality of sites and interconnected by a communication network. That is, the information processing device 1 may be implemented by a plurality of computers, and the computer program 131 may be executed on the plurality of computers connected through the communication network. The information processing device 1 may be implemented using a cloud server.

The information processing device 1 includes a simulation model for performing a shape simulation for predicting a shape of a substrate obtained by substrate processing. The simulation model processes the substrate according to a specific recipe. More specifically, the simulation model sequentially executes substrate processing according to a plurality of processing steps included in a recipe on a substrate having a predetermined initial shape, and performs a shape simulation to predict a final shape of the substrate. The simulation model includes a computer program for a shape simulation. The computer program for the shape simulation is stored in the storage 13 and included in, for example, the computer program 131.

The simulation model may be a learning model that outputs a result of the shape simulation when a recipe is input. In the embodiment, the simulation model is implemented by the calculator 11 executing information processing according to the computer program 131. For example, the simulation model is implemented by using a neural network.

The storage 13 stores a processing step database in which contents of processing steps to be included in a recipe for substrate processing are recorded. FIG. 2 is a chart illustrating an example of contents of the processing step database. In each processing step, contents of processing executed by the processing device are defined. The processing contents include processing conditions. In the example illustrated in FIG. 2, names A1, B1, and the like are given to the plurality of processing steps, respectively.

The processing contents of each processing step are recorded in association with the name of each processing step. For example, the substrate processing is etching. For example, as the processing contents of each processing step, a pressure in a process chamber, power supplied to the process chamber during etching, flow rates of a plurality of types of gases supplied to the process chamber, and a temperature in the process chamber are recorded. In the processing step, processing contents other than the pressure, the power, the gas flow rate, and the temperature may be determined. The processing contents vary for each processing step. For example, each processing step is defined by changing any of processing contents from a standard processing step. For example, the standard processing step is referred to as processing step A1.

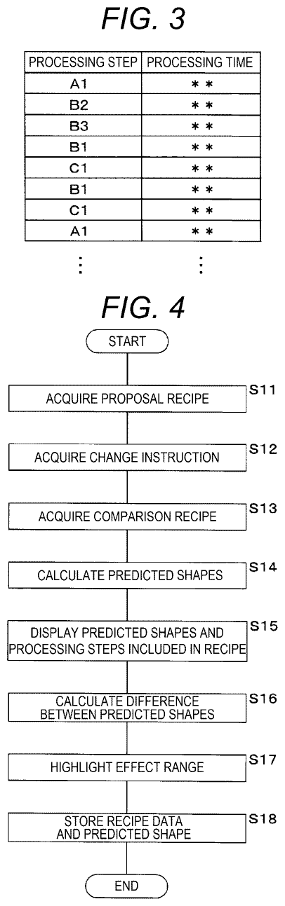

The recipe for the substrate processing is implemented by combining a plurality of processing steps whose processing contents are recorded in the processing step database. The storage 13 stores recipe data in which contents of a substrate processing recipe are recorded. FIG. 3 is a chart illustrating an example of the contents of the recipe data. In the recipe data, a plurality of processing steps to be executed, an order of executing the processing steps, and a processing time (process time) which is a time each processing step lasts are recorded. In the example illustrated in FIG. 3, the processing step is indicated by the name, and the processing time of the processing step is associated with the name of the processing step. The names of the processing steps are arranged vertically. The order in which the processing steps are arranged indicates an order in which the processing steps are executed. For example, the processing steps are executed sequentially from top to bottom. A plurality of processing steps included in one recipe may include a plurality of the same processing steps.

The information processing executed by the information processing device 1 will be described. The information processing device 1 executes the information processing for visualizing the effect of the processing step included in the substrate processing recipe on the processing result. FIG. 4 is a flowchart illustrating an example of a procedure of the information processing for visualizing the effect of the processing step that is executed by the information processing device 1. Hereinafter, the step of the information processing executed by the information processing device 1 will be abbreviated as S. The information processing device 1 executes the following processing by the calculator 11 executing the information processing according to the computer program 131.

The information processing device 1 acquires a proposal recipe proposed as a recipe defining substrate processing to be executed by a processing device (S11). In S11, the calculator 11 executes a shape simulation using a simulation model. In the shape simulation, the calculator 11 performs a simulation of substrate processing according to a certain recipe for a substrate having a predetermined initial shape, and calculates a predicted shape of the substrate. The predicted shape is a shape predicted as a final shape of the substrate obtained by the substrate processing. The calculator 11 searches for, by repeating the shape simulation while changing contents of the recipe, a recipe for obtaining a desired predicted shape. As a result of the recipe search, the calculator 11 acquires a recipe finally obtained as the proposal recipe.

The proposal recipe corresponds to a first recipe. The calculator 11 stores, in the storage 13, recipe data representing the proposal recipe. The information processing device 1 may obtain the proposal recipe by receiving recipe data from outside. The information processing device 1 may acquire the proposal recipe by reading recipe data stored in advance in the storage 13. Thereafter, the information processing device 1 performs the information processing for visualizing the effect of the processing step included in the proposal recipe.

The information processing device 1 acquires a change instruction of any of the processing steps included in the proposal recipe (S12). For example, in S12, the calculator 11 displays, on the display unit 16, a list of the plurality of processing steps included in the proposal recipe, and receives designation of any one of the plurality of processing steps by the user operating the operation unit 15. Upon receiving the designation of the processing step, the calculator 11 acquires a change instruction for changing the designated processing step. The number of processing steps instructed to be changed according to the change instruction may be one or more.

The information processing device 1 acquires a comparison recipe in which any of the processing steps included in the proposal recipe is changed (S13). The comparison recipe is a recipe for comparison with the proposal recipe, and corresponds to a second recipe. In S13, the calculator 11 acquires the comparison recipe by replacing the processing step instructed to be changed among the plurality of processing steps included in the proposal recipe with a standard processing step. For example, the standard processing step is the processing step A1, and the calculator 11 replaces the processing step instructed to be changed with the processing step A1.

By replacing the processing step instructed to be changed with the standard processing step, the information processing device 1 can easily generate the comparison recipe based on the proposal recipe. By changing the processing step instructed to be changed, the information processing device 1 specifies the processing step for which the effect is to be visualized. After changing the processing step included in the proposal recipe according to the change instruction, the information processing device 1 may acquire the comparison recipe by receiving recipe data from outside.

The information processing device 1 calculates, by the shape simulation, predicted shapes of the substrate that is subjected to the substrate processing according to the proposal recipe and the comparison recipe (S14). In S14, the calculator 11 performs a simulation of the substrate processing according to the proposal recipe using the simulation model, and calculates the predicted shape corresponding to the proposal recipe. The calculator 11 performs a simulation of the substrate processing according to the comparison recipe using the simulation model, and calculates the predicted shape corresponding to the comparison recipe. In S14, the calculator 11 calculates a three-dimensional shape of the substrate after the substrate processing as the predicted shape of the substrate, and stores, in the storage 13, shape data representing the calculated three-dimensional shape.

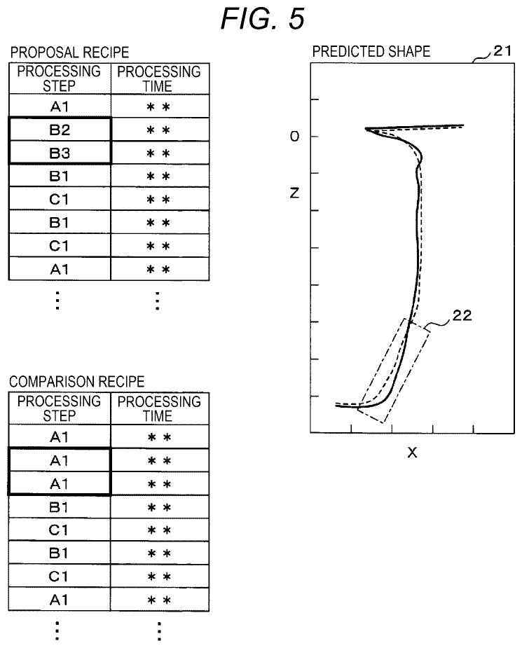

The information processing device 1 displays the predicted shapes corresponding to the proposal recipe and the comparison recipe, and the processing steps included in the proposal recipe and the comparison recipe (S15). FIG. 5 is a schematic diagram illustrating a first display example of the predicted shape and the processing steps included in each recipe. In S15, the calculator 11 displays, on the display unit 16, a chart illustrating a list of the processing steps included in the proposal recipe and a list of the processing steps included in the comparison recipe. At this time, the calculator 11 highlights and displays the processing steps that are different between the proposal recipe and the comparison recipe. In the example illustrated in FIG. 5, names of the different processing steps in the chart are framed in thick lines, so that the different processing steps are highlighted and displayed. In the example illustrated in FIG. 5, a second processing step B2 and a third processing step B3 in the proposal recipe are replaced with the processing step A1 in the comparison recipe. The information processing device 1 may highlight the processing step by another method. For example, the processing step may be highlighted by changing a color of the processing step, adding a graphic such as an arrow to the processing step, or making the processing step blink.

In S15, the calculator 11 displays, on the display unit 16, the predicted shape of the substrate that is subjected to the substrate processing according to the proposal recipe, and the predicted shape of the substrate that is subjected to the substrate processing according to the comparison recipe. In the example illustrated in FIG. 5, a graph 21 is displayed as the predicted shape, which indicates a relationship between a position of a hole in a depth direction and a width of the hole, the hole being formed in the substrate by etching. In the drawing, Z represents a depth of the hole, and X represents the width of the hole. In FIG. 5, the predicted shape corresponding to the proposal recipe is illustrated by a solid line, and the predicted shape corresponding to the comparison recipe is illustrated by a broken line. By displaying the graph 21, the user can confirm the predicted shape of the substrate that is calculated by the shape simulation. The proposal recipe and the comparison recipe include different processing steps, and therefore contents of the substrate processing are different, and the predicted shapes are different.

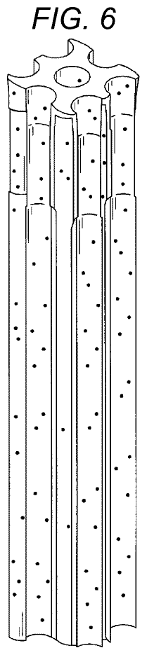

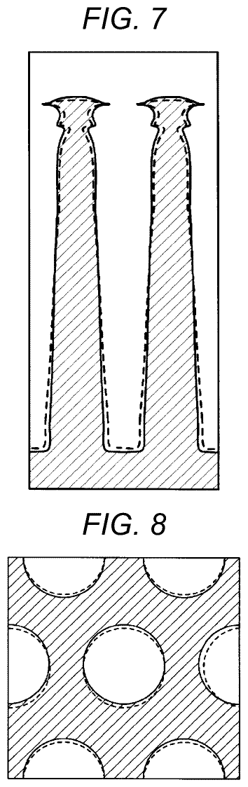

The predicted shape may be displayed in a form other than the graph 21 indicating the relationship between the depth and the width of the hole. FIG. 6 is a schematic diagram illustrating an example of a three-dimensional shape of the hole formed in the substrate. As the predicted shape, a three-dimensional shape of the substrate may be displayed as illustrated in FIG. 6. FIG. 7 is a schematic cross-sectional view illustrating an example of a cross section of the substrate taken along the depth direction of the hole. As the predicted shape, as illustrated in FIG. 7, a shape of the cross section of the substrate taken along the depth direction of the hole may be displayed. FIG. 8 is a schematic cross-sectional view illustrating an example of a cross section of the substrate taken along a direction intersecting the depth direction of the hole. As the predicted shape, as illustrated in FIG. 8, a shape of the cross section of the substrate taken along the direction intersecting the depth direction of the hole may be displayed. As the predicted shape, another shape may be displayed. For example, a top view of the substrate observed from above or a cross-sectional view at any depth position may be displayed as a diagram of the predicted shape. In FIGS. 7 and 8, as in FIG. 5, the predicted shape corresponding to the proposal recipe is illustrated by a solid line, and the predicted shape corresponding to the comparison recipe is illustrated by a broken line. Although only one three-dimensional shape is illustrated in FIG. 6, the information processing device 1 displays two three-dimensional shapes as the predicted shapes according to the proposal recipe and the comparison recipe, for example, by displaying two three-dimensional shapes in different colors. A plurality of types of predicted shapes may be switched and displayed, or a plurality of types of predicted shapes may be simultaneously displayed.

The information processing device 1 calculates a difference between the predicted shapes (S16). In S16, the calculator 11 calculates a difference between the predicted shapes that are different between the proposal recipe and the comparison recipe based on the shape data representing the predicted shapes corresponding to the proposal recipe and the comparison recipe. For example, the calculator 11 calculates a difference between widths of the hole at respective positions in the depth direction of the hole.

The information processing device 1 highlights, in the predicted shape according to the calculated difference, an effect range in which effects of the processing steps that are different between the proposal recipe and the comparison recipe are reflected (S17). In S17, the calculator 11 displays, on the display unit 16, an image for highlighting a portion of the predicted shape where the calculated difference is maximized as the effect range, superimposed on the predicted shape. FIG. 5 illustrates an example in which a frame 22 surrounding the portion where the difference is maximized is superimposed on the predicted shape to highlight the portion where the difference is maximized. The information processing device 1 may highlight the effect range by another method. For example, the effect range may be highlighted by changing a color of the effect range, adding a graphic such as an arrow to the effect range, or making the effect range blink. Alternatively, the effect range may be highlighted according to a magnitude of the difference. For example, the larger the difference, the thicker the line indicating the predicted shape in the graph 21. For example, the effect range may be highlighted according to the magnitude of the difference by using a color gradation according to the magnitude of the difference, for example, by showing the predicted shape in blue where the difference is small, and showing the predicted shape in red where the difference is large.

The proposal recipe and the comparison recipe have different processing steps, which causes a difference in predicted shape. The difference in predicted shape reflects the effect, on the predicted shape, of the processing step included in the proposal recipe that is different from the processing step included in the comparison recipe. That is, the effect of the processing step included in the proposal recipe that is replaced with the standard processing step when obtaining the comparison recipe appears as the difference in predicted shape. The portion where the difference between the predicted shape corresponding to the proposal recipe and the predicted shape corresponding to the comparison recipe is maximized is the portion where the difference in predicted shape is maximized, and is the effect range in which the effects of the processing steps that are different between the proposal recipe and the comparison recipe are best reflected.

By displaying the predicted shape corresponding to the proposal recipe and the predicted shape corresponding to the comparison recipe, the effects of the processing steps that are different between the proposal recipe and the comparison recipe can be visualized. By highlighting the portion where the difference in predicted shape is maximized, the effect range is clearly shown, and the effect of the processing step is easily confirmed. A list of the processing steps included in the proposal recipe and the processing steps included in the comparison recipe is displayed, and the different processing step is highlighted and displayed, so that the effect of which processing step is visualized becomes clear.

In the example illustrated in FIG. 5, the processing step B2 and the processing step B3 in the proposal recipe are replaced with the standard processing step A1 in the comparison recipe, and effects of the processing step B2 and the processing step B3 are visualized. In the predicted shape corresponding to the proposal recipe, a variation in width of the hole is smaller in a portion near a bottom of the hole than in the predicted shape corresponding to the comparison recipe. Therefore, as the effects of the processing step B2 and the processing step B3, an effect of making the variation in width of the hole smaller is observed in the portion near the bottom of the hole.

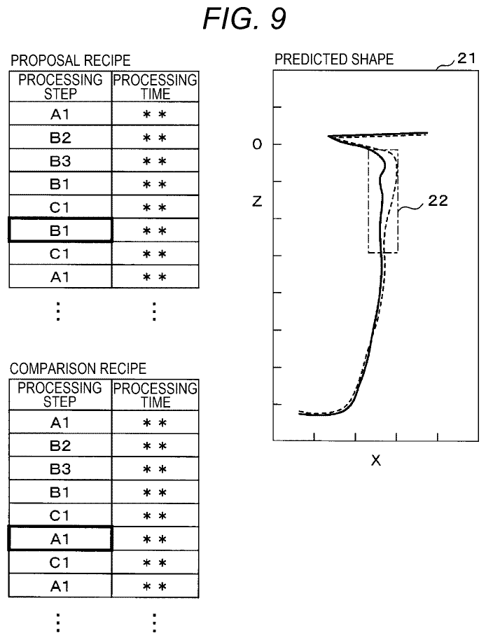

FIG. 9 is a schematic diagram illustrating a second display example of the predicted shapes and the processing steps included in each recipe. In FIG. 9, one of the processing steps B1 in the proposal recipe is replaced with the standard processing step A1 in the comparison recipe, and the effect of the processing step B1 is visualized. The predicted shape corresponding to the comparison recipe is different from the example illustrated in FIG. 5, and the position of the effect range is also different. In the predicted shape corresponding to the proposal recipe, a curvature of the width of the hole can be prevented compared to the predicted shape corresponding to the comparison recipe. Therefore, as the effect of the processing step B1, an effect of preventing the curvature of the width of the hole can be observed.

In S17, the information processing device 1 may perform processing to highlight, as an effect range, the portion where the difference between the predicted shapes falls within a predetermined range. The calculator 11 displays, on the display unit 16, an image for highlighting a portion of the predicted shape where the calculated difference falls within the predetermined range as the effect range, superimposed on the predicted shape. For example, the frame 22 surrounding the portion where the difference falls within the predetermined range is displayed superimposed on the predicted shape, and the portion where the difference falls within the predetermined range is highlighted as the effect range. For example, when the difference is small and does not reach a lower limit of the predetermined range, the influence of the difference between the processing steps on the predicted shape is small, and the effect of the processing step is not clear. When the portion where the difference between the predicted shapes falls within the predetermined range is highlighted, the effect of an obvious processing step is specified. S16 may be executed together with S14, and S17 may be executed together with S15.

The information processing device 1 stores the acquired recipe data and the predicted shape (S18). In S18, the calculator 11 stores, in the storage 13, the recipe data representing the proposal recipe and the comparison recipe and the predicted shapes corresponding to the proposal recipe and the comparison recipe. The calculator 11 may store the difference between the predicted shapes in the storage 13 in association with the recipe data and the predicted shape.

After S18 is ended, the information processing device 1 ends the information processing for visualizing the effect of the processing step. The processing in S11 to S18 can be executed as appropriate. For example, the information processing device 1 repeats the processing in S11 to S18 while changing the processing step to be replaced with the standard processing step. As a result, recipe data representing a plurality of comparison recipes in which the various processing steps included in the proposal recipe are replaced with the standard processing step, and predicted shapes corresponding to the plurality of comparison recipes are stored in the storage 13.

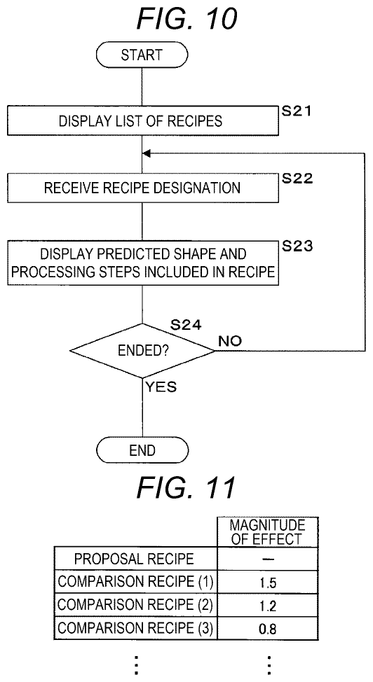

The information processing device 1 performs information processing for displaying the predicted shapes corresponding to the plurality of comparison recipes. FIG. 10 is a flowchart illustrating an example of a procedure of the information processing for displaying the predicted shapes corresponding to the plurality of comparison recipes that is executed by the information processing device 1. The information processing device 1 displays a list of recipes in which recipe data is stored (S21). In S21, the calculator 11 displays, on the display unit 16, the list of the plurality of recipes represented by the recipe data stored in the storage 13.

FIG. 11 is a schematic diagram illustrating an example of the list of the recipes. A list including the proposal recipe and the plurality of comparison recipes is displayed. In the plurality of comparison recipes, the processing steps that are different from those in the proposal recipe are different from each other. Each of the comparison recipes is associated with a magnitude of the effect of the processing step clarified by the comparison recipe. The calculator 11 displays, on the display unit 16, an absolute value of the difference between the predicted shapes as the magnitude of the effect.

The information processing device 1 receives a recipe designation from the displayed list (S22). In S22, the user operates the operation unit 15 to designate one comparison recipe from the plurality of recipes included in the displayed list. The calculator 11 receives the recipe designation from the operation unit 15.

The information processing device 1 displays the predicted shape corresponding to the designated comparison recipe, and the processing steps included in the proposal recipe and the comparison recipe (S23). In S23, the calculator 11 displays, on the display unit 16, a list of the processing steps included in the proposal recipe and the processing steps included in the comparison recipe, and the predicted shapes corresponding to the proposal recipe and the comparison recipe, as in the processing in S15. As in S17, the calculator 11 performs processing of highlighting the effect range. That is, the image as illustrated in FIG. 5 or 9 is displayed on the display unit 16.

Next, the information processing device 1 determines whether to end the processing (S24). For example, in S24, the calculator 11 determines that the processing is to be ended when an instruction for ending the processing is input through the operation of the operation unit 15 by the user. When the processing is not to be ended (S24: NO), the information processing device 1 returns the processing to S22. In S22, the calculator 11 receives the recipe designation again. When the processing is to be ended (S24: YES), the information processing device 1 ends the information processing for displaying the predicted shapes corresponding to the plurality of comparison recipes.

By executing the information processing in S21 to S24, the user selects any one of the comparison recipes, and confirms the effects of the processing steps that are different between the proposal recipe and the selected comparison recipe. The user can confirm the effects of the plurality of processing steps individually. By selecting the comparison recipe based on the magnitude of the effect, the user can check the effect of the processing step based on the magnitude of the effect. In S21, the information processing device 1 may display thumbnail images of the predicted shapes corresponding to the proposal recipe and the comparison recipe, instead of or in addition to the magnitude of the effect. By selecting the comparison recipe according to the predicted shape, the user can confirm the effect of the processing step that appears as the difference in predicted shape.

As described in detail above, in the present embodiment, the information processing device 1 calculates the predicted shapes corresponding to the proposal recipe and the comparison recipes by the shape simulation, displays the processing steps that are different between the proposal recipe and the comparison recipe, and displays the predicted shapes. The predicted shape changes depending on the difference between a part of processing steps between the proposal recipe and the comparison recipe, and the difference in predicted shape appears as the effect of the processing step. In this way, the effect of each processing step included in the recipe for the substrate processing can be visualized. By visualizing the effect of the processing step, the significance of each processing step in the substrate processing becomes clear. For example, the user may be able to explain to others why each processing step is included in the recipe. The revealed effect of each processing step becomes useful information when searching for a recipe appropriate for performing effective substrate processing. The information can support determination for the user to adjust the recipe, and the burden on the user who searches for an appropriate recipe can be reduced.

In the present embodiment, the proposal recipe is compared with one comparison recipe, but the information processing device 1 may compare the proposal recipe with the plurality of comparison recipes (e.g., a plurality of different comparison recipes). For example, the information processing device 1 may display the processing steps included in the proposal recipe and the plurality of comparison recipes and the predicted shapes corresponding to the proposal recipe and the plurality of comparison recipes in S15 or S23.

In the present embodiment, the information processing is performed regarding one proposal recipe and the comparison recipe in which a part of processing steps included in the proposal recipe are changed. The information processing device 1 may acquire a plurality of proposal recipes, and may perform the information processing in S11 to S18 and S21 to S24 for each proposal recipe.

In the present embodiment, an example has been shown in which the predicted shape of the substrate is a prediction of the final shape of the substrate obtained by the substrate processing, but the predicted shape may be a prediction of a shape other than the final shape of the substrate. The predicted shape handled in S11 to S18 and S21 to S24 may be a prediction of the shape of the substrate at a stage when the substrate processing according to any one of the processing steps included in the recipe is ended. Alternatively, the predicted shape may be a prediction of the shape of the substrate at a stage when any time has elapsed since starting substrate processing according to the recipe. Before starting substrate processing, an instruction to select either the first recipe or the second recipe as the recipe to be used in the substrate processing from a user may be input. The selected recipe may be then sent to the substrate processing apparatus. The recipe used in the apparatus may be determined either based on the user's input or according to a predetermined criterion, which may be the degree of conformity/similarity to the target shape.

In the present embodiment, etching has been mainly shown as an example of the substrate processing, but the substrate processing may be a process other than etching, such as a film formation process, as long as the process involves a shape change with respect to the substrate. The film formation process includes a process of forming a planar film on a substrate and a process of forming a film in a recess of a substrate after etching.

The present disclosure is not limited to the details of the above-described embodiment, and various modifications may be made within the scope described in the following claims. In other words, embodiments obtained by combining technical means appropriately changed within the scope indicated in the claims are also included in the technical scope of the invention.

The features described in each embodiment can be combined with each other. In addition, the independent and dependent claims set forth in the claims can be combined with each other in any and all combinations, regardless of the reciting format. Furthermore, the claims use a format of describing claims that recite two or more other claims (multi-claim format). However, the present disclosure is not limited thereto. The claims may also be described using a format of multi-claims reciting at least one multi-claim (multi-multi claims).

1. A non-transitory computer-readable storage medium comprising computer-executable program code configured to instruct a computer to execute information processing of:
acquiring a first recipe including processing steps for processing a substrate, and a second recipe in which a part of processing steps is different from those in the first recipe;
calculating, by a simulation, predicted shapes of the substrate processed according to the first recipe and the second recipe;
displaying the predicted shape corresponding to the first recipe and the predicted shape corresponding to the second recipe, and the processing steps that are different between the first recipe and the second recipe.

2. The non-transitory computer-readable storage medium according to claim 1, wherein
in the information processing executed by the computer:
an instruction for changing a part of processing steps among the processing steps included in the first recipe is acquired, and
the second recipe is acquired by changing the part of processing steps according to the acquired instruction.

3. The non-transitory computer-readable storage medium according to claim 2, wherein
in the information processing executed by the computer, the part of processing steps are changed by replacing the part of processing steps with a standard processing step.

4. The non-transitory computer-readable storage medium according to claim 1, wherein
the first recipe and the second recipe are for etching the substrate, and
the displaying the predicted shape corresponding to the first recipe and the predicted shape corresponding to the second recipe includes displaying a graph showing a relationship between a position of a hole in a depth direction and a width of the hole, the hole being formed in the substrate.

5. The non-transitory computer-readable storage medium according to claim 1, wherein
the displaying the predicted shape corresponding to the first recipe and the predicted shape corresponding to the second recipe includes displaying and highlighting a portion where a difference between the predicted shape corresponding to the first recipe and the predicted shape corresponding to the second recipe is maximum.

6. The non-transitory computer-readable storage medium according to claim 1, wherein
the displaying the predicted shape corresponding to the first recipe and the predicted shape corresponding to the second recipe includes displaying and highlighting a portion where a difference between the predicted shape corresponding to the first recipe and the predicted shape corresponding to the second recipe falls within a predetermined range.

7. The non-transitory computer-readable storage medium according to claim 1, wherein
the displaying the predicted shape corresponding to the first recipe and the predicted shape corresponding to the second recipe includes displaying a list of the processing steps included in the first recipe and the processing steps included in the second recipe, and displaying and highlighting the different processing steps.

8. An information processing method comprising:
acquiring a first recipe including processing steps for processing a substrate, and a second recipe in which a part of processing steps is different from those in the first recipe;
calculating, by a simulation, predicted shapes of the substrate processed according to the first recipe and the second recipe;
displaying the predicted shape corresponding to the first recipe and the predicted shape corresponding to the second recipe, and the processing steps that are different between the first recipe and the second recipe.

9. The information processing method according to claim 8, further comprising:
acquiring an instruction for changing a part of processing steps among the processing steps included in the first recipe; and
acquiring the second recipe by changing the part of processing steps according to the acquired instruction.

10. The information processing method according to claim 9, wherein
the part of processing steps are changed by replacing the part of processing steps with a standard processing step.

11. The information processing method according to claim 8, wherein
the first recipe and the second recipe are for etching the substrate, and
the displaying the predicted shape corresponding to the first recipe and the predicted shape corresponding to the second recipe includes displaying a graph showing a relationship between a position of a hole in a depth direction and a width of the hole, the hole being formed in the substrate.

12. The information processing method according to claim 8, wherein
the displaying the predicted shape corresponding to the first recipe and the predicted shape corresponding to the second recipe includes displaying and highlighting a portion where a difference between the predicted shape corresponding to the first recipe and the predicted shape corresponding to the second recipe is maximum.

13. The information processing method according to claim 8, wherein
the displaying the predicted shape corresponding to the first recipe and the predicted shape corresponding to the second recipe includes displaying and highlighting a portion where a difference between the predicted shape corresponding to the first recipe and the predicted shape corresponding to the second recipe falls within a predetermined range.

14. The information processing method according to claim 8, wherein
the displaying the predicted shape corresponding to the first recipe and the predicted shape corresponding to the second recipe includes displaying a list of the processing steps included in the first recipe and the processing steps included in the second recipe, and displaying and highlighting the different processing steps.

15. An information processing device comprising:
circuitry configured to:
acquire a first recipe including processing steps for processing a substrate, and a second recipe in which a part of processing steps is different from those in the first recipe,
calculate, by a simulation, predicted shapes of the substrate processed according to the first recipe and the second recipe,
display the predicted shape corresponding to the first recipe and the predicted shape corresponding to the second recipe, and the processing steps that are different between the first recipe and the second recipe, and
cause the processing of the substrate using one of the first recipe and the second recipe.

16. The information processing device according to claim 15, wherein the circuitry is further configured to:
acquire an instruction for changing a part of processing steps among the processing steps included in the first recipe; and
acquire the second recipe by changing the part of processing steps according to the acquired instruction.

17. The information processing device according to claim 16, wherein
the part of processing steps are changed by replacing the part of processing steps with a standard processing step.

18. The information processing device according to claim 15, wherein
the first recipe and the second recipe are for etching the substrate, and
the displaying the predicted shape corresponding to the first recipe and the predicted shape corresponding to the second recipe includes displaying a graph showing a relationship between a position of a hole in a depth direction and a width of the hole, the hole being formed in the substrate.

19. The information processing device according to claim 15, wherein
the displaying the predicted shape corresponding to the first recipe and the predicted shape corresponding to the second recipe includes displaying and highlighting a portion where a difference between the predicted shape corresponding to the first recipe and the predicted shape corresponding to the second recipe is maximum.

20. The information processing device according to claim 15, wherein
the displaying the predicted shape corresponding to the first recipe and the predicted shape corresponding to the second recipe includes displaying a list of the processing steps included in the first recipe and the processing steps included in the second recipe, and displaying and highlighting the different processing steps.
